(19) United States
(12) Patent Application Publication
(10) Pub. No.: US 2025/0198027 A1
(43) Pub. Date: Jun. 19, 2025

(54) ELECTROCATALYST, CATHODE AND ELECTROCHEMICAL SYSTEM INCLUDING THE ELECTROCATALYST, AND PREPARATION METHOD OF THE ELECTROCATALYST

(71) Applicants: Samsung Electronics Co., Ltd., Suwon-si (KR); Seoul National University R&DB Foundation, Seoul (KR)

(72) Inventors: Kang Hee Cho, Suwon-si (KR); Dayeon Kim, Seoul (KR); Yun Jeong Hwang, Seoul (KR); Minkyung Kim, Suwon-si (KR); JAEEUN Kim, Suwon-si (KR); Noho Lee, Suwon-si (KR); SANG MIN JI, Suwon-si (KR)

(21) Appl. No.: 18/809,455

(22) Filed: Aug. 20, 2024

(30) Foreign Application Priority Data
Dec. 13, 2023 (KR) 10-2023-0181159

(51) Int. Cl. C25B 11/091; C25B 3/26; C25B 9/19; C25B 9/23; C25B 11/02; C25B 11/052; C25B 11/065

(52) U.S. Cl. CPC C25B 11/091; C25B 9/19; C25B 9/23; C25B 11/02; C25B 11/052; C25B 11/065; C25B 3/26

(57) ABSTRACT

An electrocatalyst including: a first nanostructure including copper hydroxide; and a second nanostructure including a metal of Groups 2, 4, or 11 to 14 of the Periodic Table of Elements, other than copper, a metal oxide of the metal, a metal hydroxide of the metal, or a combination thereof, wherein the electrocatalyst is effective to catalyze conversion of carbon dioxide into a multicarbon compound.

### CROSS-REFERENCE TO RELATED APPLICATION

This application claims priority to Korean Patent Application No. 10-2023-0181159, filed on Dec. 13, 2023, in the Korean Intellectual Property Office, and all the benefits accruing therefrom under 35 U.S.C. § 119, the contents of which is incorporated herein in its entirety by reference.

### BACKGROUND

### 1. Field

This disclosure relates to an electrocatalyst, a cathode and electrochemical system including the same, and a method of preparing the electrocatalyst.

### 2. Description of the Related Art

Greenhouse gases such as carbon dioxide are generated through the use of fossil fuels. Greenhouse gases cause climate change, including global warming.

Multicarbon compounds are mainly obtained from petrochemical processes using fossil fuels. Converting carbon dioxide into multicarbon compounds may reduce the generation of carbon dioxide caused by the use of fossil fuels in petrochemical processes.

Various methods of converting carbon dioxide into multicarbon compounds are being studied, however, there remains a need for an improved method.

### SUMMARY

Methods of converting carbon dioxide into other compounds using metal catalysts such as copper (Cu) are being studied. A method of electrochemically reducing carbon dioxide by a copper catalyst may be performed at a low temperature of 100° C. or less, for example, room temperature, and at an atmospheric pressure. By the copper catalyst, carbon dioxide may be converted into hydrogen, methane, carbon monoxide, etc. Because a wide variety of compounds are produced in the process of converting carbon dioxide by copper, selectivity for a desired compound is reduced. The copper catalyst includes active sites that may adsorb carbon dioxide. Because the copper catalyst has limited types of active sites, catalytic activity of the copper catalyst is limited.

Therefore, a new electrocatalyst that may provide an increased number of active site types for carbon dioxide and improved selectivity for multicarbon compounds is desired.

Provided is an electrocatalyst having a new structure that may provide improved catalytic activity by providing an increased number of active site types for carbon dioxide.

Provided is an electrocatalyst having a new structure that may provide improved selectivity for multicarbon compounds generated from carbon dioxide.

Provided is a cathode including the electrocatalyst.

Provided is an electrochemical system including the electrocatalyst.

Provided is a method of preparing the electrocatalyst.

Additional aspects will be set forth in part in the description which follows and, in part, will be apparent from the description, or may be learned by practice of the presented embodiments of the disclosure.

According to an aspect of the disclosure, an electrocatalyst includes:
a first nanostructure including copper hydroxide, and
a second nanostructure including
   a metal of Groups 2, 4, or 11 to 14 of the Periodic Table of Elements, other than copper,
   a metal oxide including the metal,
   a metal hydroxide including the metal, or
   a combination thereof.

According to another aspect of the disclosure, a cathode includes the electrocatalyst.

According to another aspect of the disclosure, an electrochemical system includes the cathode, an anode, and an electrolyte disposed between the cathode and the anode.

According to another aspect of the disclosure, a method of preparing an electrocatalyst includes:
providing a first nanostructure; and
disposing a second nanostructure on the first nanostructure to prepare the electrocatalyst, wherein the first nanostructure is a 1-dimensional nanostructure, and the second nanostructure is a 0-dimensional nanostructure, and
wherein the first nanostructure includes copper hydroxide, and
the second nanostructure includes
   a metal of Groups 2, 4, or 11 to 14 of the Periodic Table of Elements, other than copper,
   a metal oxide including the metal,
   a metal hydroxide including the metal, or
   a combination thereof.

According to another aspect of the disclosure, a method of preparing an electrocatalyst includes:
simultaneously preparing a first nanostructure and a second nanostructure disposed on the first nanostructure to prepare the electrocatalyst,
wherein the first nanostructure and the second nanostructure are each a 0-dimensional nanostructure,
the first nanostructure includes copper hydroxide, and
the second nanostructure includes
   a metal of Groups 2, 4, or 11 to 14 of the Periodic Table of Elements, other than copper,
   a metal oxide including the metal,
   a metal hydroxide including the metal, or
   a combination thereof.

According to an aspect, a method of converting carbon dioxide to a multicarbon compound includes:
providing an electrochemical system including
   a cathode comprising the electrocatalyst,
   an anode, and
   an electrolyte disposed between the cathode and the anode;
supplying carbon dioxide to the cathode;
supplying water to the anode; and
supplying electrical energy between the cathode and the anode to convert carbon dioxide to the multicarbon compound.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a scanning electron microscopy (SEM) image of an electrocatalyst prepared in Example 1;

FIG. 2 is an SEM image of an electrocatalyst prepared in Example 3;

FIG. 3A is an SEM image of an electrocatalyst prepared in Example 5;

FIG. 3B is an SEM image of the electrocatalyst prepared in Example 5;

FIG. 4A is an SEM image of an electrocatalyst prepared in Comparative Example 1;

FIG. 4B is an SEM image of the electrocatalyst prepared in Comparative Example 1;

FIG. 5 is a graph of intensity (arbitrary units, a.u.) vs. diffraction angle (°2θ) and shows X-ray diffraction (XRD) spectra for the electrocatalysts prepared in Example 1, Example 3, and Comparative Example 1;

FIG. 6 is a graph of counts per second per electronvolts (cps/eV) vs. energy (kiloelectronvolts, keV) and shows an energy dispersive X-ray (EDX) spectrum for the electrocatalyst prepared in Example 1;

FIG. 7 is a schematic diagram showing an electrochemical system according to an embodiment;

FIG. 8 is a schematic diagram showing an H-type electrochemical system according to an embodiment;

FIG. 9 is a schematic diagram showing a flow electrochemical system according to an embodiment; and

FIG. 10 is a schematic diagram showing a membrane electrode assembly (MEA) electrochemical system according to an embodiment.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terminology (including technical and scientific terminology) used in this disclosure have the same meaning as commonly understood by those skilled in the art to which this disclosure pertains. Additionally, terms as defined in commonly used dictionaries should be interpreted as having meanings consistent with their meanings within the context of the related art and disclosure, and should not be interpreted in an idealized or overly formal sense.

Exemplary embodiments are described in this disclosure with reference to cross-sectional diagrams, which are schematic diagrams of idealized embodiments. As such, variations from the shown shape should be expected, for example as a result of preparing techniques and/or tolerances. Accordingly, the examples described in this disclosure should not be construed as limited to the specific shapes of the regions as shown in this disclosure, but should include variations in shapes resulting, for example, from preparing. For example, regions shown or described as flat may typically have rough and/or non-linear features. Moreover, angles shown as sharp may be rounded. Accordingly, the regions shown in the drawings are schematic in nature and their shapes are not intended to depict the exact shape of the regions and are not intended to limit the scope of the claims.

The inventive concept may be embodied in many different forms, and should not be construed as limited to the embodiments described in this disclosure. The examples are provided so that the disclosure will be thorough and complete, and will fully convey the scope of the inventive concept to those skilled in the art. Like reference numerals refer to like elements.

It may be understood that when an element is referred to as being “on” another element, it may be directly on top of the other element, or there may be other elements intervening between them. In contrast, when an element is said to be “directly on” another element, there are no intervening elements between them.

Terms such as “first,” “second,” and “third” may be used herein to describe various elements, components, regions, layers, and/or sections, these elements, components, regions, layers and/or sections should not be limited by these terms. These terms are only used to distinguish one element, component, region, layer or section from another. Thus, a first element, component, region, layer or section described below may refer to a second element, component, region, layer or section, without departing from the teachings of the disclosure.

The terms used herein are for the purpose of describing particular embodiments only and is not intended to limit the inventive concept. As used herein, the singular forms “a,” “an,” and “the” are intended to include the plural forms, including “at least one,” unless the context clearly dictates otherwise. Thus, reference to “an” element in a claim followed by reference to “the” element is inclusive of one element and a plurality of the elements. The wording “at least one” should not be construed as limited to being singular. As used herein, the term “and/or” includes any and all combinations of one or more of the listed items. When used in the detailed description, the terms “comprises” and/or “comprising” specify the presence of the stated features, regions, integers, steps, operations, elements, components and/or ingredients, but do not preclude the presence or addition of one or more other features, regions, integers, steps, operations, elements, components and/or groups thereof.

Spatially relative terms such as “beneath,” “below,” “lower,” “above,” “upper,” etc. may be used herein for ease of description to describe one element or feature's relationship to another element(s) or feature(s). It will be understood that spatially relative terms are intended to encompass different orientations of the device in use or operation in addition to the orientation depicted in the drawings. For example, if the device in the drawings is turned over, elements described as “beneath” or “below” other elements or features would then be oriented “above” the other elements or features. Accordingly, the exemplary term “below” may encompass both an orientation of above and below. The device may be otherwise oriented (rotated 90 degrees or at other orientations) and the spatially relative terms used herein may be interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.).

In this disclosure, “Group” means a group of the Periodic Table of the Elements according to the International Union of Pure and Applied Chemistry (“IUPAC”) 1-18 Group classification system.

In the disclosure, a “size” of a particle refers to a “particle diameter” or a “major axis length” of the particle, unless otherwise defined.

In the disclosure, a “particle diameter” indicates an average diameter of the particle when the particle is spherical. The “major axis length” indicates an average major axis length of the particle when the particle is non-spherical. A “minor axis length” indicates an average minor axis length of the particle when the particle is non-spherical. In an aspect, the size of the particles may be measured using a particle size analyzer (PSA). The “particle diameter” is, for example, an average particle diameter. The average particle diameter is, for example, the median particle diameter (D50). The median particle diameter (D50) is a particle size corresponding to 50% of the cumulative volume calculated from a small-sized particle side in a particle size distribution measured, for example, by a laser diffraction method. Alternatively, the “average particle size” may be determined manually or by software from a scanning electron microscope (SEM) image or a transmission electron microscope (TEM) image.

A “nanostructure” of a particle herein may be determined from, for example, scanning electron microscopy (SEM) or transmission electron microscopy (TEM) images.

In the disclosure, “metal” includes both metals and metalloids such as silicon and germanium, in elemental or ionic states.

In this disclosure, “alloy” means a mixture of two or more metals.

In this disclosure, “electrochemical system” refers to a system that causes electrochemical oxidation and electrochemical reduction by using electrical energy.

In the disclosure, “cathode” and “negative electrode” refer to the electrode where electrochemical reduction occurs.

In the disclosure, “anode” and “positive electrode” refer to the electrode where electrochemical oxidation occurs.

Hereinafter, an electrocatalyst according to exemplary embodiments, a cathode including the same, an electrochemical system including the same, and a method for preparing the same will be described in more detail.

### Electrocatalyst

An electrocatalyst according to an embodiment is configured to convert carbon dioxide into a multicarbon compound (e.g., multicarbon compounds). The electrocatalyst may include a first nanostructure and a second nanostructure having a structure different from the first nanostructure. Alternatively, the electrocatalyst may include the first nanostructure and the second nanostructure having a size different from the first nanostructure. The first nanostructure includes copper hydroxide (Cu(OH)₂). The second nanostructure includes a metal other than copper. The second nanostructure includes the metal (e.g., one or more metals) of Groups 2, 4, or 11 to 14 of the Periodic Table of Elements, a metal oxide including the one or more metals, a metal hydroxide including the one or more metals, or a combination thereof.

In an aspect, the electrocatalyst comprises: the first nanostructure comprising copper hydroxide; and the second nanostructure comprising the metal of Groups 2, 4, or 11 to 14 of the Periodic Table of Elements, other than copper, the metal oxide of the metal, the metal hydroxide of the metal, or a combination thereof, wherein the electrocatalyst is effective to catalyze conversion of carbon dioxide into the multicarbon compound.

The electrocatalyst converts carbon dioxide into multicarbon compounds. The multicarbon compounds are, for example, compounds including two or more carbons. The multicarbon compounds may be, for example, an oligomer having 2 or more carbon atoms or a polymer compound having 2 or more carbon atoms. The multicarbon compounds are compounds including, for example, 2 to 10, 2 to 5, or 2 to 4 carbon atoms. The multicarbon compounds include, for example, ethylene, ethane, ethanol, acetic acid, propanol, etc.

The electrocatalyst may provide an increased number of active site types for carbon dioxide, by simultaneously including the first nanostructure and the second nanostructure having a different structure and/or size from the first nanostructure. The electrocatalyst may be provided with improved catalytic activity for carbon dioxide. The electrocatalyst may demonstrate, for example, improved current densities for the reduction of carbon dioxide.

The electrocatalyst capable of providing improved selectivity for multicarbon compounds generated from carbon dioxide may be provided by simultaneously including the first nanostructure and the second nanostructure having the different structure from the first nanostructure. The electrocatalyst may represent, for example, increased current densities for multicarbon compounds.

By including copper hydroxide in the first nanostructure, multicarbon compounds may be provided through an electrochemical reduction reaction of carbon dioxide.

By including, in the second nanostructure, one or more metals of Groups 2, 4, or 11 to 14 of the Periodic Table of Elements, the metal oxide (e.g., oxide) of the one or more metals, the metal hydroxide (e.g., hydroxide) of the one or more metals, or a combination thereof, adsorption properties for carbon dioxide may be improved. Therefore, by including, in the second nanostructure, such one or more metals, the metal oxide including such one or more metals, the metal hydroxide including such one or more metals, or a combination thereof, reaction efficiency and/or reaction selectivity of the carbon dioxide reduction reaction may be further improved. The second nanostructure may not include, for example, copper.

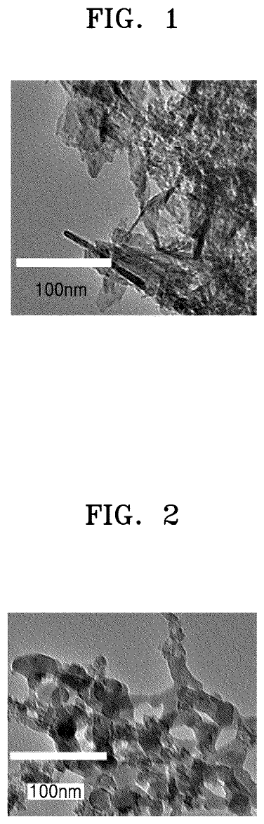

In an aspect, the electrocatalyst further comprises a complex comprising the first nanostructure and the second nanostructure, wherein the second nanostructure is dispersed and supported on the first nanostructure. For example, the electrocatalyst may include a complex in which one or more second nanostructures are dispersed and supported on the first nanostructure. Referring to FIGS. 1, 2, 3A, and 3B, the electrocatalyst may have the form of a complex in which the second nanostructure is dispersed and supported on the first nanostructure. By having such a form, the electrocatalyst may have an increased number of reaction site types for catalytic reaction. As a result, the catalytic activity of the electrocatalyst may be further improved, and the selectivity for multicarbon compounds may be improved. The number of second nanostructures supported on one first nanostructure may be about 0.01 to about 100, about 0.1 to about 10, about 0.5 to about 5, or about 1 to about 5.

Alternatively, although not shown in the drawings, the electrocatalyst may include, for example, a mixture of the first nanostructure and the second nanostructure. By including such a mixture, the electrocatalyst may have an increased number of reaction site types for the catalytic reaction. As a result, the catalytic activity of the electrocatalyst may be further improved, and the selectivity for multicarbon compounds may be improved. The mixing ratio of the first nanostructure and the second nanostructure may be about 99:1 to about 1:99, about 95:5 to about 5:95, or about 90:10 to about 10:90. The mixing ratio of the first nanostructure and the second nanostructure may be about 99:1 to about 50:50, about 95:5 to about 60:40, or about 90:10 to about 70:30. The mixing ratio may be a molar ratio or a weight ratio.

The electrocatalyst may include, for example, the first nanostructure and the second nanostructure, and the first nanostructure and the second nanostructure may each independently include a 0-dimensional nanostructure, a 1-dimensional nanostructure, a 2-dimensional nanostructure, a 3-dimensional nanostructure, or a combination thereof. By including such nanostructures in the electrocatalyst, the catalytic activity of the electrocatalyst may be improved, and the selectivity for multi-carbon compounds may be further improved. The structure, or a diameter, a thickness, a length, an area, etc. of the nanostructure may be determined by, for example, a scanning electron microscope, a transmission electron microscope, etc.

The 0-dimensional nanostructure is, for example, a particulate structure. The 0-dimensional nanostructure is, for example, a structure in which the size of all dimensions is about 1 nanometer (nm) to about 100 nm, for example, about 5 nm to about 90 nm, or about 10 nm to about 80 nm. The 0-dimensional nanostructure may include, for example, a nanoparticle, a nanocube, or a combination thereof, but is not limited thereto, and any suitable 0-dimensional nanostructure used in the art may be used.

The 1-dimensional nanostructure is a linear structure with a minor axis length of about 100 nm or less, for example, about 1 nm to about 100 nm, about 5 nm to about 90 nm, or about 10 nm to about 80 nm. The 1-dimensional nanostructure is, for example, a structure in which lengths of two or more dimensions are about 100 nm or less. A length of a remaining dimension is at least 5 times the length of the dimension equal to and less than 100 nm. For example, a major axis length of a 1-dimensional nanostructure is at least 5 times the minor axis length. The 1-dimensional nanostructure may include, for example, a nanorod, a nanowire, a nanofiber, a nanotube, or a combination thereof, but is not limited thereto, and any suitable 1-dimensional nanostructure used in the art is applicable.

The 2-dimensional nanostructure is a structure with a thickness of 100 nm or less, for example, about 1 nm to about 100 nm, about 5 nm to about 90 nm, or about 10 nm to about 80 nm. The 2-dimensional structure is, for example, a structure in which a minor axis length (i.e., a length of an axis having a shortest length) of one dimension is 100 nm or less. A length of a remaining dimension is at least 10 times the length of the dimension equal to or less than 100 nm. For example, the major axis length (i.e., a length of an axis having a longest length in the direction perpendicular to the thickness direction) of the 2-dimensional nanostructure is at least 10 times the thickness. The 2-dimensional nanostructure includes, for example, a nanosheet, a nanoflake, a nanoplate, a nanobelt, or a combination thereof, but is not limited thereto, and any suitable 2-dimensional nanostructure used in the art is applicable.

The 3-dimensional nanostructure may have an assembled form of one or more of the above-described 0-dimensional nanostructure, 1-dimensional nanostructure, or 2-dimensional nanostructure. The 3-dimensional nanostructure may have a regular or irregular shape. One or more of the 0-dimensional nanostructure to the 2-dimensional nanostructure may be connected to one another or aggregated together, to form the 3-dimensional nanostructure.

The electrocatalyst may include, for example, the first nanostructure and the second nanostructure, and the first nanostructure may include the nanoparticle, the nanorod, or a combination thereof, and the second nanostructure may include the nanoparticle. In an aspect, the nanoparticle included in the first nanostructure, and the nanoparticle included in the second nanostructure may be the same or different. For example, the first nanostructure may include the nanorod, and the second nanostructure may include the nanoparticle. By including such nanostructures, the electrocatalyst may provide further improved catalytic activity and/or selectivity for multicarbon compounds.

For example, the electrocatalyst may include the first nanostructure, and the first nanostructure may include the 1-dimensional nanostructure. The first nanostructure may include, for example, the nanorod. An aspect ratio of the first nanostructure may be, for example, about 5 to about 200, about 10 to about 200, about 10 to about 150, about 10 to about 100, or about 10 to about 50. In an aspect, the aspect ratio refers to the major axis length divided by the minor axis length of the nanostructure. The electrocatalyst may provide further improved catalytic activity and/or selectivity for multicarbon compounds by including the first nanostructure having an aspect ratio in this range. The aspect ratio of the first nanostructure may be determined, for example, from a scanning electron microscopy image or a transmission electron microscopy image of the first nanostructure.

The electrocatalyst may include, for example, the first nanostructure, and the first nanostructure may have a primary structure consisting of one nanostructure, the secondary structure that is an aggregate of a plurality of primary structures, or a combination thereof.

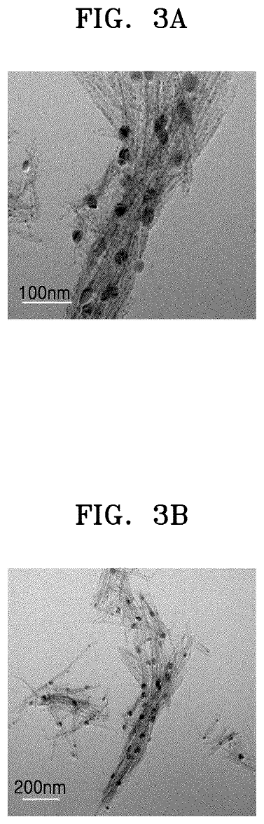

The primary structure may include a 0-dimensional nanostructure, for example, a nanoparticle. The primary structure may include, for example, a 1-dimensional nanostructure. The primary structure may include a nanorod, for example. A major axis length of the primary structure may be, for example, about 20 nm to about 1 μm, about 20 nm to about 800 nm, about 20 nm to about 500 nm, about 50 nm to about 300 nm, or about 50 nm to about 200 nm. A minor axis length of the primary structure may be, for example, about 1 nm to about 50 nm, about 1 nm to about 40 nm, about 1 nm to about 30 nm, about 1 nm to about 30 nm, or about 1 nm to about 10 nm. Referring to FIGS. 1 and 2, it is shown that the first nanostructure comprises the primary structure consisting of one nanostructure. In FIG. 1, the primary structure is a nanorod. In FIG. 2, the primary structure is a nanoparticle.

The secondary structure may include an aggregate of a plurality of 0-dimensional nanostructures, for example, an aggregate of a plurality of nanoparticles. The secondary structure may include an aggregate of a plurality of 1-dimensional nanostructures. The secondary structure may include, for example, an aggregate of a plurality of nanorods. A major axis length of the secondary structure may be, for example, about 100 nm to about 5 μm, about 500 nm to about 5 μm, about 500 nm to about 3 μm, or about 500 nm to about 2 μm. A minor axis length of the secondary structure may be, for example, about 5 nm to about 500 nm, about 10 nm to about 500 nm, about 50 nm to about 400 nm, or about 100 nm to about 300 nm. Referring to FIGS. 2, 3A, and 3B, it is shown that the first nanostructure comprises the secondary structure that is an aggregate of the plurality of primary structures. In FIG. 2, the secondary structure is an aggregate of nanoparticles. In FIGS. 3A and 3B, the secondary structure is an aggregate of nanorods.

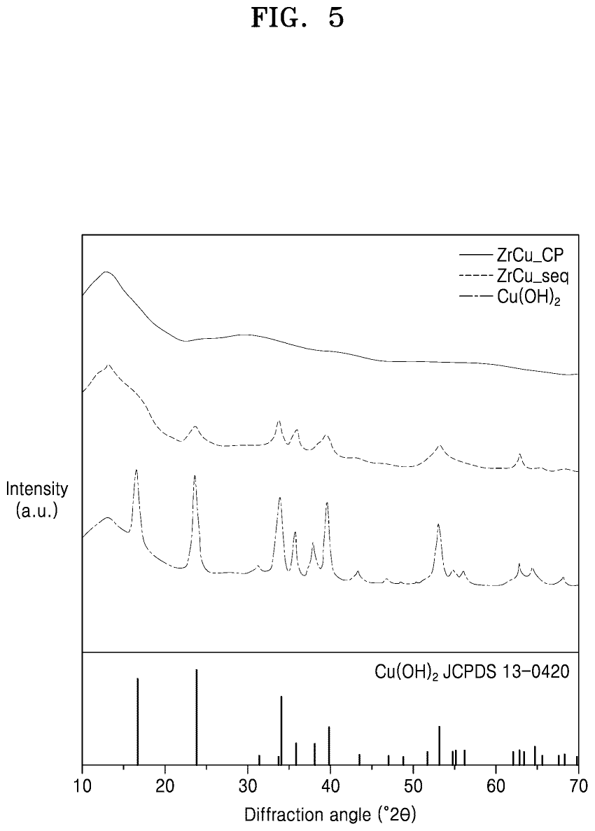

The first nanostructure may include, for example, a crystalline nanostructure. In an aspect, the first nanostructure is crystalline. The first crystalline nanostructure is, for example, a crystalline nanorod. In an aspect, the first nanostructure comprises the crystalline nanostructure, and the electrocatalyst comprises a first peak at a diffraction angle (2θ) of 24±1°2θ and a second peak at a diffraction angle (2θ) of 24±1° 2θ, when analyzed by X-ray diffraction using CuKα radiation. Referring to FIG. 5, the XRD spectrum of the electrocatalyst including the first crystalline nanostructure shows a first peak derived from a (021) plane at a diffraction angle (2θ) of 24±1° 2θ and a second peak derived from a (002) plane at a diffraction angle (2θ) of 24±1° 2θ.

The first nanostructure may include, for example, an amorphous nanostructure. The first amorphous nanostructure is, for example, an amorphous nanoparticle. In an aspect, the first nanostructure comprises the amorphous nanostructure, and the electrocatalyst is free of the first peak at a diffraction angle (2θ) of 24±1°2θ, and is free of the second peak at a diffraction angle (2θ) of 24±1°2θ, when analyzed by X-ray diffraction using CuKα radiation. Referring to FIG. 5, the XRD spectrum of the electrocatalyst including the first amorphous nanostructure did not show a crystalline peak. The XRD spectrum of the electrocatalyst including the first amorphous nanostructure is free of a first peak derived from a (021) plane at a diffraction angle (2θ) of 24±1°2θ, and is also free of a second peak derived from a (002) plane at a diffraction angle (2θ) of 24±1°2θ.

The electrocatalyst may include the first nanostructure, and the first nanostructure may further include, for example, copper metal, copper oxide, or a combination thereof. By additionally including copper metal, copper oxide, etc. in the first nanostructure, the number of reaction site types of the electrocatalyst may increase, thereby improving catalytic activity. The first nanostructure may further include copper metal, copper oxide, etc., in addition to copper hydroxide (Cu(OH)₂). The copper oxide may be represented by, for example, CuₓO_{y} (0<x≤1, and 0<y≤1). Copper oxide may be, for example, Cu₂O, CuO, etc. The first nanostructure mainly includes copper hydroxide and may partially include one or more of copper metal and copper oxide. A content of copper metal included in the first nanostructure may be about 5 atomic percent (at %) or less, about 3 at % or less, or about 1 at % or less, for example, 0 at % to about 5 at %, about 0.1 at % to about 3 at %, or about 0.5 at % to about 1 at %, based on a total amount of the first nanostructure. A content of copper oxide included in the first nanostructure may be about 5 at % or less, about 3 at % or less, or about 1 at % or less, for example, 0 at % to about 5 at %, about 0.1 at % to about 3 at %, or about 0.5 at % to about 1 at %, based on the total amount of the first nanostructure.

Alternatively, the first nanostructure may not additionally include copper metal, copper oxide, etc. By not additionally including copper metal, copper oxide, etc. in the first nanostructure, the electrocatalyst may provide further improved selectivity for multicarbon compounds.

The electrocatalyst includes the second nanostructure, and the second nanostructure may include the metal of Ba, Sr, Ca, Mg, Zr, Ti, Ag, Au, B, Al, In, Sn, or a combination thereof. By including such a metal in the second nanostructure, the catalytic activity of the electrocatalyst may be improved, and the selectivity for multi-carbon compounds may be further improved.

The electrocatalyst may include the second nanostructure, and the second nanostructure may include a metal oxide including the metal of Ba, Sr, Ca, Mg, Zr, Ti, Ag, Au, B, Al, In, Sn, or a combination thereof. The metal oxide may include, for example, BaOₓ (0<x≤1), SrOₓ (0<x≤1), CaOₓ (0<x≤1), MgOₓ (0<x≤1), ZrOₓ (0<x≤2), TiOₓ (0<x≤2), Ag₂Oₓ (0<x≤1), Au₂Oₓ (0<x≤3), B₂Oₓ (0<x≤3), Al₂Oₓ (0<x≤3), In₂Oₓ (0<x≤3), SnOₓ (0<x≤2) or a combination thereof. The metal oxide may include, for example, BaO, SrO, CaO, MgO, ZrO₂, TiO, TiO₂, Ti₂O₃, Ti₃O₅, Ag₂O, Au₂O₃, B₂O₃, Al₂O₃, In₂O₃, SnO₂, or a combination thereof. By including such a metal oxide in the second nanostructure, the catalytic activity of the electrocatalyst may be improved, and the selectivity for multi-carbon compounds may be further improved.

The electrocatalyst includes the second nanostructure, and the second nanostructure may include a metal hydroxide including the metal of Ba, Sr, Ca, Mg, Zr, Ti, Ag, Au, B, Al, In, Sn, or a combination thereof. The metal hydroxide may include, for example, Ba(OH)_{y} (0<y≤2), Sr(OH)_{y} (0<y≤2), Ca(OH)_{y} (0<y≤2), Mg(OH)_{y} (0<y≤2), Zr(OH)_{y} (0<y≤4), Ti(OH)_{y} (0<y≤4), Ag(OH)_{y} (0<y≤1), Au(OH)_{y} (0<y≤3), B(OH)_{y} (0<y≤3), Al(OH)_{y} (0<y≤3), In(OH)_{y} (0<y≤3), Sn(OH)_{y} (0<y≤4), or a combination thereof. The metal hydroxide may include, for example, Ba(OH)₂, Sr(OH)₂, Ca(OH)₂, Mg(OH)₂, Zr(OH)₄, Ti(OH)₂, Ti(OH)₃, Ti(OH)₄, Ag(OH), Au(OH)₃, B(OH)₃, Al(OH)₃, In(OH)₃, Sn(OH)₄, or a combination thereof. By including such a metal hydroxide in the second nanostructure, the catalytic activity of the electrocatalyst may be improved, and the selectivity for multi-carbon compounds may be further improved.

The electrocatalyst may include the second nanostructure, and the second nanostructure may be, for example, amorphous. The second nanostructure may not exhibit crystalline peaks in an XRD spectrum. The second nanostructure may be, for example, an amorphous metal, an amorphous metal oxide, an amorphous metal hydroxide, or a combination thereof.

Alternatively, the electrocatalyst may include the second nanostructure, and the second nanostructure may be, for example, crystalline.

The electrocatalyst may include the first nanostructure and the second nanostructure, and a size of the second nanostructure may be smaller than a size of the first nanostructure. The size of the second nanostructure may be, for example, about 90% or less, about 70% or less, about 50% or less, about 30% or less, or about 10% or less of the size of the first nanostructure. The size may be, for example, a length (e.g., major axis length) of a nanorod or a particle size (e.g., particle diameter) of a nanoparticle. The size of the second nanostructure may be, for example, about 100 nm or less, about 50 nm or less, about 30 nm or less, about 20 nm or less, or about 10 nm or less. The size of the second nanostructure may be, for example, about 1 nm to about 100 nm, about 1 nm to about 50 nm, about 2 nm to about 30 nm, about 3 nm to about 20 nm, or about 5 nm to about 10 nm. By having a size in such ranges in the second nanostructure, the number of reaction site types and the effective reaction area may be increased, such that the catalytic activity of the electrocatalyst may be further improved and the selectivity for other compounds may be further improved. The size of the second nanostructure may be measured using, for example, a scanning electron microscope or a transmission electron microscope.

The electrocatalyst may include the first nanostructure and the second nanostructure, and a content of the metal included in the second nanostructure may be greater than 0 at % but less than about 50 at %, greater than 0 at % but not greater than about 40 at %, about 1 at % to about 30 at %, about 5 at % to about 30 at %, about 10 at % to about 30 at %, about 15 at % to about 30 at %, or about 15 at % to about 25 at %, with respect to a total metal amount included in the first nanostructure and the second nanostructure. In an aspect, the total metal amount in the first nanostructure and the second nanostructure refers to an amount of Cu in the first nanostructure and an amount of the metal in the second nanostructure. In an aspect, the total metal amount in the first nanostructure and the second nanostructure refers to an amount of Cu and a secondary metal other than Cu in the first nanostructure and the amount of the metal in the second nanostructure. The content of the metal included in the second nanostructure may be calculated, for example, from energy dispersive X-ray spectroscopy (EDS) data. By having the content of the metal included in the second nanostructure within this range, the catalytic activity of the electrocatalyst may be improved and the selectivity for multi-carbon compounds may be further improved.

The electrocatalyst may further include a carbon-containing (i.e., carbon-based) support. The electrocatalyst may include the carbon-based support, the first nanostructure, and the second nanostructure, and at least one of the first nanostructure or the second nanostructure may be supported on the carbon-based support. By supporting one or more of the first nanostructure or the second nanostructure on the carbon-based support, an area of the three-phase interface where solid, liquid, and gas simultaneously come into contact may be further increased, such that the efficiency of the catalytic reaction may be further improved. The carbon-based support may include, for example, carbon black, carbon nanotube, graphene, carbon nanofiber, graphite, or a combination thereof, but is not limited thereto, and any suitable conductive material used in the art which is inert to the carbon dioxide reduction reaction is applicable.

### Cathode

A cathode according to another embodiment includes the electrocatalyst described above. By including the above-described electrocatalyst, the cathode may provide improved catalytic activity for the carbon dioxide reduction reaction and improved selectivity for multicarbon compounds.

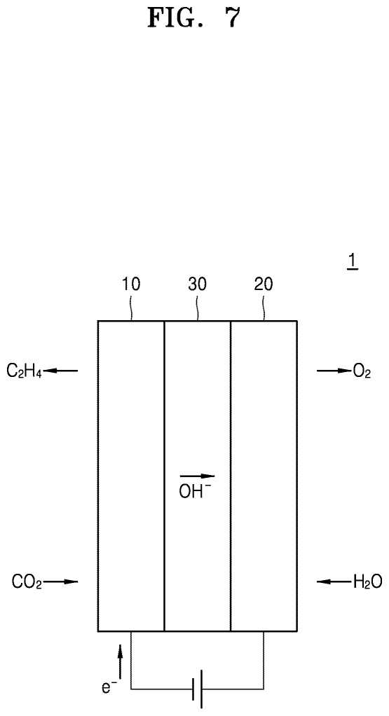

Referring to FIGS. 7 to 10, the electrochemical systems 1, 1a, 1b, and 1c include a cathode 10. The cathode 10 includes, for example, a catalyst layer 11 and a gas diffusion layer 12. The catalyst layer 11 includes the electrocatalyst.

The catalyst layer 11 may further include, for example, one or more of a conductive material or a binder.

The conductive material may be, for example, a carbon-based conductive material or a metal-containing (e.g., metal-based) conductive material. The carbon-based conductive material may include, for example, carbon black, carbon nanotube, graphene, carbon nanofiber, graphite, or a combination thereof, but is not limited thereto, and any suitable material that is inert to the carbon dioxide reduction reaction and has electronic conductivity is applicable. An amount of the conductive material may be, for example, about 20 weight percent (wt %) or less, about 10 wt % or less, or about 5 wt % or less of a total weight of the catalyst layer 11. The conductive material may be omitted.

The binder may be, for example, an ion-conductive binder. The binder may be an ionomer, for example, Nafion. The binder may provide cohesion and/or ionic conductivity. The binder content may be, for example, about 20 wt % or less, about 10 wt % or less, or about 5 wt % or less of the total weight of the catalyst layer 11. The binder may be omitted.

The cathode may be prepared, for example, by mixing the electrocatalyst and the ion-conductive binder to prepare a cathode catalyst ink, and then applying and drying the cathode catalyst ink onto a porous support. The porous support is, for example, carbon paper.

### Electrochemical System

An electrochemical system according to another embodiment includes: the above cathode for converting carbon dioxide into multicarbon compounds; an anode; and an electrolyte disposed between the cathode and the anode. By including the electrocatalyst described above, the electrochemical system provides high catalytic activity for the carbon dioxide reduction reaction and improved selectivity for multicarbon compounds.

FIG. 7 is a schematic diagram showing the electrochemical system according to an embodiment.

Referring to FIG. 7, the electrochemical system 1 includes a cathode 10, an anode 20, and an electrolyte 30 disposed between the cathode 10 and the anode 20. Electrical energy is supplied between the cathode 10 and the anode 20. Carbon dioxide is supplied to the cathode 10, and multicarbon compounds, which are reduction products of carbon dioxide, are discharged from the cathode 10. The cathode 10 is a fuel electrode because the cathode 10 contacts carbon dioxide, which is a fuel, and a reduction reaction proceeds thereon. For example, water is supplied to the anode 20, and oxygen is discharged from the anode 20. The anode 20 is an oxygen electrode because the anode 20 contacts oxygen, and an oxidation reaction proceeds thereon. The electrolyte 30 may be a cationic conductive electrolyte or an anionic conductive electrolyte. The cation is, for example, a proton. The anion is, for example, a hydroxy ion. The electrolyte may be a liquid electrolyte, a solid electrolyte, a gel electrolyte, or a combination thereof.

As described in the reaction scheme below, an electrochemical reaction of the electrochemical system 1 includes a reduction reaction in which carbon dioxide (CO₂) is converted to multicarbon compounds (e.g., C₂H₄) at the cathode 10 and an oxygen evolution reaction (OER) in which hydroxy ions that diffuse through the electrolyte 30 are converted to oxygen gas (O₂). The OER is, for example, an oxidation reaction. The following reaction is carried out using an anionic conductive electrolyte.

### Reaction Scheme

Cathode: 2CO₂+8H₂O+12e⁻→C₂H₄+12OH⁻—
Anode: 4OH⁻→O₂+2H₂O+4e

The overall reaction of conversion from carbon dioxide to multicarbon compounds may be expressed as follows:
2CO₂+2H₂O→C₂H₄+3O₂

When electrical energy is supplied to the electrochemical system 1 from an external power source, electrons are provided to the electrochemical system 1 from the external power source.

The electrons react with carbon dioxide provided to the cathode 10, to generate multicarbon compounds and hydroxy ions. The multicarbon compound (e.g., ethylene) gas is discharged to the outside, and the hydroxy ions pass through the electrolyte 30 (e.g., an anion-conductive electrolyte) and move to the anode 20. The hydroxy ions that move to the anode 20 lose electrons and are converted to water and oxygen and discharged to the outside. Although not shown in the drawing, a gas supply channel may be disposed on one side of the cathode 10 and a gas supply channel may be disposed on one side of the anode 20.

The electrolyte in the electrochemical system includes, for example, a liquid electrolyte, solid electrolyte, a gel electrolyte, or a combination thereof.

The liquid electrolyte may be, for example, an acidic solution or a basic solution. The liquid electrolyte may be, for example, an aqueous solution. The liquid electrolyte may be, for example, an acidic solution including hydrochloric acid, sulfuric acid, nitric acid, etc. The liquid electrolyte may be, for example, a basic solution including NaOH, KOH, etc. The liquid electrolyte may include, for example, an ionic liquid.

The solid electrolyte may include, for example, a cationic conductive polymer, a cationic conductive solid oxide, an anionic conductive polymer, an anionic conductive solid oxide, etc. The anionic conductive polymers include, for example, Sustainion anion exchange membrane, Nafion, Fumasep FAPQ-375, AMI07001, polybenzimidazole (PBI), Neosepta ACN, etc.

The gel electrolyte may include, for example, a cationic conductive polymer, an anionic conductive polymer, a mixture of a cationic conductive polymer and a liquid electrolyte, a mixture of an anionic conductive polymer and a liquid electrolyte, etc.

The electrochemical system may be, for example, an H-type electrochemical system, a flow electrochemical system or a membrane electrode assembly (MEA) electrochemical system. The electrochemical system may be, for example, an electrolyzer cell. The electrochemical system may be, for example, an H-type cell, a flow cell, or a membrane electrode assembly (MEA) cell.

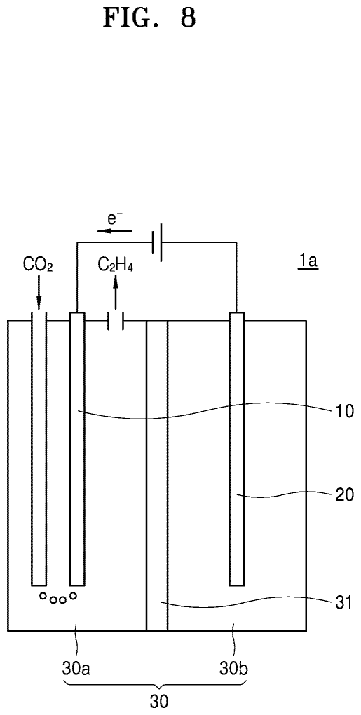

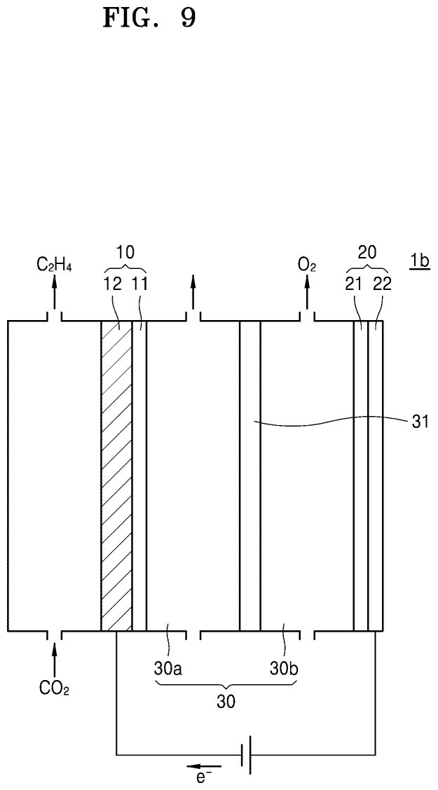

FIG. 8 is a schematic diagram showing an H-type electrochemical system 1a according to an embodiment.

Referring to FIG. 8, in the H-type electrochemical system 1a, a cathode chamber including a catholyte 30a and an anode chamber including an anolyte 30b are separated by an ion-exchange membrane (IEM) 31. The cathode chamber includes a working electrode (WE) 10. The WE 10 is a cathode. The anode chamber includes a counter electrode (CE) 20. The CE 20 is an anode. Carbon dioxide is continuously supplied to the cathode electrolyte 30a, and for the carbon dioxide reduction reaction, carbon dioxide is transferred by diffusion within the catholyte 30a to the surface of the working electrode 11. The H-type electrochemical system 1a has a simple structure and is easy to operate, and thus may be widely used for testing electrocatalysts for carbon dioxide reduction reactions.

FIG. 9 is a schematic diagram showing a flow electrochemical system 1b according to an embodiment.

Referring to FIG. 9, the flow electrochemical system 1b includes a cathode chamber including the cathode 10, an anode chamber including the anode 20, and the ion-exchange membrane 31 disposed between the cathode 10 and the anode 20. The cathode 10 includes the cathode catalyst layer 11 and the gas diffusion layer 12. The anode 20 includes the anode catalyst layer 21 and a substrate 22. The catholyte 30a is continuously supplied between the cathode 10 and the ion-exchange membrane 31. The anolyte 30b is continuously supplied between the anode 20 and the ion-exchange membrane 31. In the flow system 1b, carbon dioxide is supplied to the cathode catalyst layer 11 through the cathode gas diffusion layer 12, and thus the mass transfer of carbon dioxide is significantly improved compared to that in the H-type electrochemical system, and the concentration of carbon dioxide is increased within the cathode 10. In the flow system 1b, the distance between the cathode 10 and the anode 20 is relatively reduced compared to that in the H-type electrochemical system, and thus the system resistance may be reduced. Therefore, the reversibility of the electrode reaction is improved. As a result, the current density and performance of the carbon dioxide reduction reaction may be improved. In the flow system 1b, carbon dioxide, the catholyte 30a, and the anolyte 30b are continuously supplied, and thus the carbon dioxide reduction reaction proceeds continuously, thereby improving reaction efficiency.

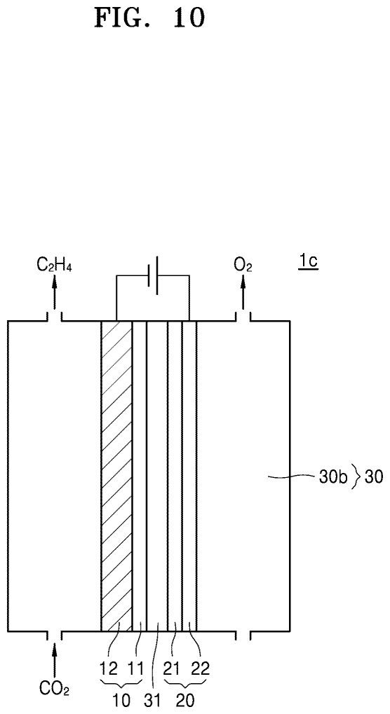

FIG. 10 is a schematic diagram showing a membrane electrode assembly (MEA) electrochemical system 1c according to an embodiment.

Referring to FIG. 10, the MEA electrochemical system 1c includes a cathode chamber including the cathode 10, an anode chamber including the anode 20, and the ion-exchange membrane 31 disposed between the cathode 10 and the anode 20. The cathode 10 and the ion-exchange membrane 31 are in direct contact. The cathode 10 includes the cathode catalyst layer 11 and the gas diffusion layer 12. The anode 20 includes the anode catalyst layer 21 and the porous substrate 22. In the MEA electrochemical system 1c, there is no gap between the gas diffusion layer 12, the catalyst layer 11, and the ion-exchange membrane 31, and thus electrolyte overflow may be prevented compared to the flow electrochemical system 1b, and since the catholyte is excluded, system resistance may be further reduced. Therefore, the reversibility of the electrode reaction is improved. As a result, the current density and performance of the carbon dioxide reduction reaction may be further improved. In the MEA electrochemical system 1c, carbon dioxide and the anolyte 30b are continuously supplied, and thus the carbon dioxide reduction reaction proceeds continuously, thereby improving reaction efficiency.

In an aspect, a carbon capture system or a carbon sequestration system may comprise the electrochemical system comprising the electrocatalyst.

### Electrocatalyst Preparation Method I (Sequential Precipitation)

A method for preparing an electrocatalyst according to another embodiment includes: a) providing (e.g., preparing) a first nanostructure; and b) disposing (e.g., supporting) a second nanostructure on the first nanostructure to prepare the electrocatalyst. The first nanostructure may be a 1-dimensional nanostructure. The second nanostructure may be a 0-dimensional nanostructure. The first nanostructure includes copper hydroxide and the second nanostructure includes a metal other than copper. The second nanostructure includes the metal of Groups 2, 4, 11 to 14 of the Periodic Table of Elements, or a combination thereof, other than copper, a metal oxide including the metal, a metal hydroxide including the metal, or a combination thereof. By sequentially preparing the first nanostructure and the second nanostructure, the first nanostructure and the second nanostructure have different structures, and an electrocatalyst in the form of a complex including the first nanostructure and the second nanostructure supported on the first nanostructure is prepared. Such an electrocatalyst may provide improved catalytic activity and improved selectivity for multicarbon compounds. The preparation of the electrocatalyst may be performed at room temperature and atmospheric pressure. The room temperature and the atmospheric pressure are, for example, 25° C. and 1 atm, respectively.
a) A first nanostructure is prepared.

First, a first solution including a precursor of the first nanostructure is prepared. The precursor of the first nanostructure is, for example, a copper-containing precursor compound. The copper-containing precursor compound is not particularly limited, and any suitable water-soluble compound containing copper is applicable. The copper-containing precursor compound includes, but is not limited to, copper halide salts, copper nitrates, copper sulfates, copper phosphates, etc. The copper-containing precursor compound is, for example, Cu(NO₃)₂·3H₂O.

A precursor content of the first nanostructure included in the first solution may be, for example, about 0.01 molar (M) to about 10 M, about 0.1 M to about 10 M, about 0.1 M to about 5 M, or about 0.1 to about 2 M. The solvent of the first solution may be water, alcohol, etc. The solvent is, for example, distilled water.

Next, a first basic solution is added to the first solution to prepare a second solution including the first nanostructure.

The first basic solution is, for example, an aqueous solution including the first basic compound. The first basic compound is, for example, NaOH, KOH, etc., but is not limited thereto. The first basic solution may be, for example, a strong base solution with a pH of about 10 or greater. The pH of the first basic solution may be, for example, about 10 or greater, about 11 or greater, about 12 or greater, or about 13 or greater. The first nanostructure may be formed from the copper-containing precursor included in the first solution by adding the first basic solution to the first solution resulting in a second solution, or by adding the first basic solution to the first solution and stirring. The stirring may be carried out for about 1 minute to about 24 hours, about 1 minute to about 12 hours, about 1 minute to about 2 hours, or about 1 minute to about 1 hour, and the stirring speed may be, for example, about 100 rotations per minute (rpm) to about 2000 rpm or about 300 rpm to about 900 rpm. The first nanostructure may precipitate at the bottom of a reactor, or may exist in a dispersed state in the second solution. Referring to FIG. 1, the first nanostructure may be, for example, a copper hydroxide nanorod. The second solution including copper hydroxide nanorods as the first nanostructure is prepared.
b) The second nanostructure is supported on the first nanostructure.

First, a fourth solution is prepared by adding a third solution including a precursor of the second nanostructure to the second solution.

The third solution including the precursor of the second nanostructure is prepared. The precursor of the second nanostructure is, for example, a precursor compound including the metal, of Groups 2, 4, 11 to 14 of the Periodic Table of Elements, or a combination thereof, other than copper. The precursor compound including the metal is not particularly limited, and any suitable water-soluble compound including the metal is applicable. The precursor compound including the metal may include, for example, but is not limited to, halogen salts of zirconium, oxyhalogen salts of zirconium, nitrates of zirconium, sulfates of zirconium, phosphates of zirconium, halogen salts of titanium, oxyhalogen salts of titanium, nitrates of titanium, sulfates of titanium, phosphates of titanium, etc. The zirconium-including precursor compound is, for example, ZrO(NO₃)₂·xH₂O, wherein 0≤x≤6.

A precursor content of the second nanostructure included in the third solution is not particularly limited. The precursor content of the second nanostructure included in the third solution may be, for example, about 0.01 M to about 10 M, about 0.01 M to about 5 M, about 0.01 M to about 2 M, or about 0.01 M to about 1 M. The solvent of the third solution may be water, alcohol, etc. The solvent may be, for example, distilled water.

A content of the third solution added to the second solution may be adjusted in consideration of the content of the second nanostructure included in the electrocatalyst.

Next, a fifth solution including a first precipitate is prepared by adding the second basic solution to the fourth solution.

The second basic solution is, for example, an aqueous solution including a second basic compound distinct from the first basic compound. The second basic compound is, for example, Na₂CO₃ or the like. The second basic solution may be, for example, a strongly basic solution with a pH of about 10 or greater. The pH of the second basic solution may be, for example, about 10 or greater, about 11 or greater, about 12 or greater, or about 13 or greater. The first precipitate may be formed by adding the second basic solution to the fourth solution resulting in the fifth solution, or by adding the second basic solution to the fourth solution and stirring.

The stirring may be carried out, for example, for about 1 minute to about 24 hours, about 1 minute to about 12 hours, about 1 minute to about 2 hours, or about 1 minute to about 1 hour.

The stirring speed may be, for example, about 100 rpm to about 2000 rpm or about 300 rpm to about 900 rpm.

During such an addition and/or stirring process, the second nanostructure may precipitate and be supported on the first nanostructure. The first precipitate may precipitate at the bottom of a reactor, or may exist in a dispersed state in the fifth solution. The fifth solution including the first precipitate is prepared.

Next, the first precipitate is separated from the fifth solution to prepare the electrocatalyst.

The fifth solution is placed in a centrifuge and centrifuged to remove the supernatant and separate the first precipitate. The first precipitate is washed with isopropanol or the like. The washed first precipitate is dried in a vacuum oven to obtain the electrocatalyst.

The electrocatalyst includes the first nanostructure and the second nanostructure supported on the first nanostructure. The first nanostructure is, for example, a nanorod and the second nanostructure is, for example, a nanoparticle.

In an aspect, a method of preparing an electrocatalyst comprises:
providing a first nanostructure; and
   disposing a second nanostructure on the first nanostructure to prepare the electrocatalyst,
   wherein the first nanostructure is a 1-dimensional nanostructure, and the second nanostructure is a 0-dimensional nanostructure, and
   wherein the first nanostructure comprises copper hydroxide, and
   the second nanostructure comprises
   a metal of Groups 2, 4, or 11 to 14 of the Periodic Table of Elements, other than copper,
   a metal oxide of the metal,
   a metal hydroxide of the metal, or
   a combination thereof.

In an aspect, the providing the first nanostructure comprises:
preparing a first solution comprising a precursor of the first nanostructure; and
adding a first basic solution to the first solution to prepare a second solution comprising the first nanostructure, and the disposing the second nanostructure on the first nanostructure comprises:
adding a third solution comprising a precursor of the second nanostructure to the second solution to prepare a fourth solution;
adding a second basic solution to the fourth solution to prepare a fifth solution comprising a first precipitate; and
separating the first precipitate from the fifth solution.

### Electrocatalyst Preparation Method II (Co-Precipitation Method)

A method of preparing an electrocatalyst according to another embodiment includes c) simultaneously preparing a first nanostructure and a second nanostructure supported on the first nanostructure. The first nanostructure and the second nanostructure may each be a 0-dimensional nanostructure. The first nanostructure includes copper hydroxide, and the second nanostructure includes a metal other than copper. The second nanostructure includes the metal of Groups 2, 4, or 11 to 14 of the Periodic Table of Elements, other than copper, a metal oxide including the metal, a metal hydroxide including the metal, or a combination thereof. By preparing the first nanostructure and the second nanostructure simultaneously, the first nanostructure and the second nanostructure have different sizes, and the electrocatalyst in the form of a complex including the first nanostructure and the second nanostructure supported on the first nanostructure is prepared. Such an electrocatalyst may provide improved catalytic activity and/or improved selectivity for multicarbon compounds. The preparation of the electrocatalyst may be performed at room temperature and atmospheric pressure. The room temperature and the atmospheric pressure are, for example, 25° C. and 1 atm, respectively. The size of the first nanostructure is larger than the size of the second nanostructure.
c) The first nanostructure and the second nanostructure supported on the first nanostructure are prepared simultaneously.

First, a sixth solution including a precursor of the first nanostructure and a precursor of the second nanostructure is prepared.

The precursor of the first nanostructure is, for example, a copper-containing precursor compound. The copper-containing precursor compound is not particularly limited, and any suitable water-soluble compound containing copper is applicable. The copper-containing precursor compound may include, for example, but is not limited to, halide salts of copper, nitrates of copper, sulfates of copper, and phosphates of copper.

The copper-containing precursor compound is, for example, Cu(NO₃)₂·3H₂O. A precursor content of the first nanostructure included in the sixth solution may be, for example, about 0.01 M to about 10 M, about 0.1 M to about 10 M, about 0.1 M to about 5 M, or about 0.1 M to about 2 M. A solvent of the sixth solution may be water, alcohol, etc. The solvent is, for example, distilled water.

The precursor of the second nanostructure is, for example, a precursor compound including the metal of Groups 2, 4, 11 to 14 of the Periodic Table of Elements, or a combination thereof, other than copper. The precursor compound including the metal is not particularly limited, and any suitable water-soluble compound including the metal is applicable. The precursor compound including the metal may include, for example, but is not limited to, halogen salts of zirconium, oxyhalogen salts of zirconium, nitrates of zirconium, sulfates of zirconium, phosphates of zirconium, halogen salts of titanium, oxyhalogen salts of titanium, nitrates of titanium, sulfates of titanium, and phosphates of titanium. The zirconium-including precursor compound is, for example, ZrO(NO₃)₂·xH₂O, wherein 0≤x≤6. A precursor content of the second nanostructure included in the sixth solution is not particularly limited. The precursor content of the second nanostructure included in the sixth solution may be, for example, about 0.01 M to about 10 M, about 0.01 M to about 5 M, about 0.01 M to about 2 M, or about 0.01 M to about 1 M.

Next, at least one of the first basic solution or the second basic solution is added to the sixth solution to prepare a seventh solution including a second precipitate.

The first basic solution is, for example, an aqueous solution including a first basic compound. The first basic compound is, for example, NaOH, KOH, etc., but is not limited thereto. The first basic solution may be, for example, a strongly basic solution with a pH of about 10 or greater. The pH of the first basic solution may be, for example, about 10 or greater, about 11 or greater, about 12 or greater, or about 13 or greater.

The second basic solution is, for example, an aqueous solution including a second basic compound distinct from the first basic compound. The second basic compound is, for example, Na₂CO₃ or the like. The second basic solution may be, for example, a strongly basic solution of pH of about 10 or greater. The pH of the second basic solution may be, for example, about 10 or greater, about 11 or greater, about 12 or greater, or about 13 or greater.

The second precipitate may be formed by adding one or more of the first basic solution or the second basic solution to the sixth solution, or by adding one or more of the first basic solution or the second basic solution to the sixth solution and stirring.

The stirring may be carried out, for example, for about 1 minute to about 24 hours, about 1 minute to about 12 hours, about 1 minute to about 2 hours or about 1 minute to about 1 hour.

The stirring speed may be, for example, about 100 rpm to about 2000 rpm or about 300 rpm to about 900 rpm. During such an addition and/or stirring process, the first nanostructure and the second nanostructure may precipitate simultaneously.

The second precipitate may precipitate at the bottom of a reactor, or may exist in a dispersed state in the seventh solution. The seventh solution including the second precipitate is prepared.

Next, the second precipitate is separated from the seventh solution to prepare the electrocatalyst.

The seventh solution is placed in a centrifuge and centrifuged to remove the supernatant and separate the second precipitate. The second precipitate is washed with isopropanol or the like. The washed second precipitate is dried in a vacuum oven to obtain an electrocatalyst.

The electrocatalyst includes the first nanostructure and the second nanostructure supported on the first nanostructure. The first nanostructure and the second nanostructure are each nanoparticles, and the sizes thereof are different.

In an aspect, the method of preparing the electrocatalyst comprises:
simultaneously preparing a first nanostructure and a second nanostructure disposed on the first nanostructure to prepare the electrocatalyst,
   wherein the first nanostructure and the second nanostructure are each a 0-dimensional nanostructure, and
   wherein the first nanostructure comprises copper hydroxide, and
   the second nanostructure comprises
   a metal of Groups 2, 4, or 11 to 14 of the Periodic Table of Elements, other than copper,
   a metal oxide of the metal,
   a metal hydroxide of the metal, or
   a combination thereof.

In an aspect, the simultaneous preparing of the first nanostructure and the second nanostructure disposed on the first nanostructure comprises
preparing a sixth solution comprising a precursor of the first nanostructure and a precursor of the second nanostructure,
adding at least one of a first basic solution or a second basic solution to the sixth solution to prepare a seventh solution comprising a second precipitate, and
separating the second precipitate from the seventh solution to prepare the electrocatalyst.

In an aspect, a method of converting carbon dioxide to a multicarbon compound (e.g., a method of producing a multicarbon compound) comprises:
providing an electrochemical system comprising
   a cathode comprising the electrocatalyst,
   an anode, and
   an electrolyte disposed between the cathode and the anode;
supplying carbon dioxide to the cathode;
supplying water to the anode; and
supplying electrical energy between the cathode and the anode to convert carbon dioxide to the multicarbon compound.

The disclosure will be explained in more detail through Examples and Comparative Examples below. However, these Examples are for illustrating the disclosure, and are not intended to limit the scope of the disclosure.

### EXAMPLES

### Preparation of Electrocatalyst

### Example 1: ZrOₓ Nanoparticles Supported on Cu(OH)₂ Nanorods, Zr 10 at % (Sequential Precipitation Method)

Cu(NO₃)₂·3H₂O as a precursor of the first nanostructure was added to distilled water and stirred to prepare a first solution including 0.2 M of the precursor of the first nanostructure.

10 milliliters (mL) of a 0.5 M NaOH solution as a first basic solution was added dropwise to 10 mL of the first solution to prepare a mixed solution.

The reaction was performed while stirring the mixed solution at room temperature at a speed of 600 rpm for 40 minutes to prepare a second solution including the first nanostructure.

ZrO(NO₃)₂·xH₂O (0≤x≤6) was added to distilled water and stirred to prepare a third solution including the precursor of the second nanostructure.

The third solution was added to the second solution and stirred for 10 minutes to prepare a fourth solution.

A 0.1 M Na₂CO₃ solution as a second basic solution was added to the fourth solution and stirred for an additional 20 minutes to prepare a fifth solution including a precipitate.

The fifth solution was put into a centrifuge, centrifuged to remove the supernatant, and then washed with isopropanol to separate the precipitate.

The separated precipitate was dried in a vacuum oven for 12 hours to prepare an electrocatalyst.

As shown in FIG. 1, the prepared electrocatalyst included a Cu(OH)₂ nanorod as the first nanostructure and amorphous ZrOₓ (0<x≤2) as the second nanostructure, and had the form of a complex in which amorphous ZrOₓ (0<x≤2) nanoparticles were supported on Cu(OH)₂ nanorods.

The major axis length of Cu(OH)₂ nanorods was 100 nm.

The particle size of ZrOₓ (0<x≤2) was 5 nm to 10 nm. The content of Zr was 10 at % based on the total content of metals (total of Cu and Zr) included in the electrocatalyst. Cu and Zr contents were measured through energy dispersive X-ray spectroscopy (EDS) analysis.

### Example 2: Zr Nanoparticles Supported on Cu(OH)₂ Nanorods, 20 at % Zr (Sequential Precipitation Method)

An electrocatalyst was prepared in the same manner as in Example 1, except that the Zr content was changed to 20 at % based on the total content of metals (sum of Cu and Zr contents) included in the electrocatalyst.

### Example 3: Zr Nanoparticles Supported on Cu(OH)₂ Nanoparticles (Co-Precipitation Method)

Cu(NO₃)₂·3H₂O as a precursor of the first nanostructure was added to distilled water and stirred to prepare a first solution including 0.2 M of the precursor of the first nanostructure.

ZrO(NO₃)₂·xH₂O (0≤x≤6) was added to distilled water and stirred to prepare a third solution including the precursor of the second nanostructure.

The first solution and the third solution were mixed at a certain ratio to prepare a sixth solution.

14 mL of a 0.5 M NaOH solution as a first basic solution was added dropwise to 10 mL of the sixth solution to prepare a mixed solution.

The reaction was carried out while stirring the mixed solution at room temperature at a speed of 600 rpm for 30 minutes to prepare a seventh solution including a precipitate.

The seventh solution was put into a centrifuge, centrifuged to remove the supernatant, and then washed with isopropanol to separate the precipitate.

The separated precipitate was dried in a vacuum oven for 12 hours to prepare an electrocatalyst.

As shown in FIG. 2, the prepared electrocatalyst included Cu(OH)₂ nanoparticles as the first nanostructure and amorphous ZrOₓ nanoparticles as the second nanostructure, and had the form of a complex in which ZrOₓ nanoparticles are supported on the Cu(OH)₂ nanoparticles. The size of the first nanostructure was larger than the size of the second nanostructure. The particle size of Cu(OH)₂ nanoparticles was larger than that of ZrOₓ nanoparticles.

### Example 4: Mixture of Cu(OH)₂ Nanorods and Zr Nanoparticles (Prepared Separately and then Mixed)

### Preparation of First Nanostructure

Cu(NO₃)₂·3H₂O as a precursor of the first nanostructure was added to distilled water and stirred to prepare a first solution including 0.2 M of the precursor of the first nanostructure.

10 mL of a 0.5 M NaOH solution as a first basic solution was added dropwise to 10 mL of the first solution to prepare a mixed solution.

The reaction was carried out while stirring the mixed solution at room temperature at a speed of 600 rpm for 40 minutes to prepare a second solution including the precipitate.

A 0.1 M Na₂CO₃ solution as a second basic solution was added to the second solution and stirred for an additional 20 minutes to prepare a third solution including a precipitate.

The third solution was put into a centrifuge, centrifuged to remove the supernatant, and then washed with isopropanol to separate the precipitate.

The separated precipitate was dried in a vacuum oven for 12 hours to prepare a first nanostructure. The first nanostructure was Cu(OH)₂ nanorod.

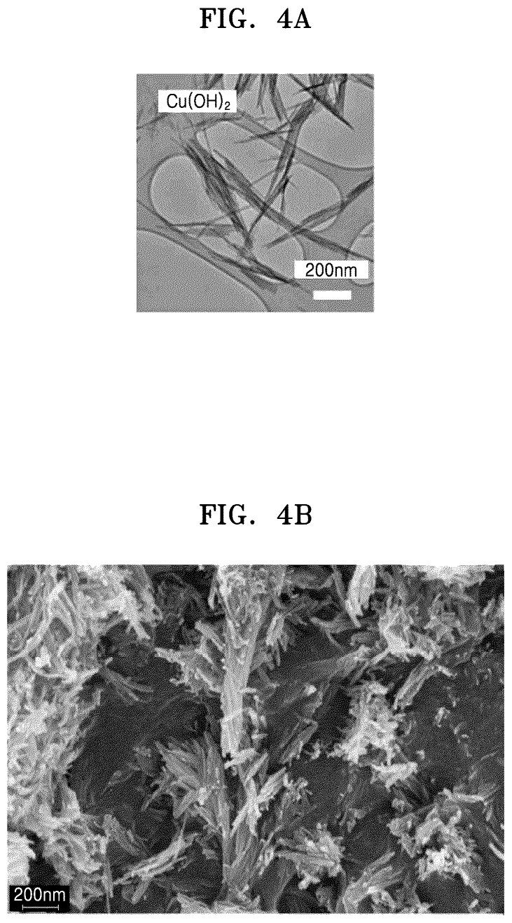

As shown in FIGS. 4A and 4B, the first nanostructure included Cu(OH)₂ nanorods.

### Preparation of Second Nanostructure

ZrO(NO₃)₂·xH₂O was added to distilled water and stirred to prepare a third solution including 0.02 M of the precursor of the second nanostructure.

A 0.1 M Na₂CO₃ solution as a second basic solution was added to the third solution and further stirred at 600 rpm for 30 minutes to prepare a solution including a precipitate.

The solution including the precipitate was put into a centrifuge, centrifuged to remove the supernatant, and washed with isopropanol to separate the precipitate.

The separated precipitate was dried in a vacuum oven for 12 hours to prepare a second nanostructure. The second nanostructure was amorphous ZrOₓ nanoparticles.

### Preparation of Electrocatalyst

The first nanostructure and the second nanostructure were mixed to prepare an electrocatalyst.

The electrocatalyst was a mixture of Cu(OH)₂ nanorods and ZrOₓ nanoparticles.

The content of Zr was 10 at % based on the total content of metals (sum of Cu and Zr contents) included in the electrocatalyst.

### Example 5: Ti Nanoparticles Supported on Cu(OH)₂ Nanorods, Ti 10 at % (Sequential Precipitation Method)

An electrocatalyst was prepared in the same manner as in Example 1, except that C₁₂H₂₈O₄Ti was used instead of ZrO(NO₃)₂·xH₂O (0≤x≤6) as the precursor of the second nanostructure, and a 0.1 M Na₂CO₃ solution as the second basic solution was added and stirred.

As shown in FIGS. 3A and 3B, the electrocatalyst includes Cu(OH)₂ nanorods as the first nanostructure and Ti nanoparticles as the second nanostructure, and had the form of a complex in which Ti nanoparticles are supported on a Cu(OH)₂ nanorod.

The Cu(OH)₂ nanorod primary structure had a diameter of about 10 nm to about 20 nm, a major axis length of about 100 nm to about 200 nm, and an aspect ratio of about 10 to about 20. The particle size of the Ti nanoparticles was about 20 nm.

The secondary structure, which is an aggregate of the Cu(OH)₂ nanorod primary structure, had a diameter of about 100 nm to about 200 nm and a major axis length of about 500 nm to about 1 μm.

The Ti content was 10 at % based on the total contents of metals (sum of Cu and Ti contents) included in the electrocatalyst.

### Comparative Example 1: Cu(OH)₂ Nanorod

A first nanostructure was prepared in the same manner as the first nanostructure preparation method in Example 4. The first nanostructure was a Cu(OH)₂ nanorod.

The first nanostructure was used as an electrocatalyst.

### Comparative Example 2: Cu Nanoparticles

Cu nanoparticle powder with a particle diameter of 50 nm was used as an electrocatalyst.

### Comparative Example 3: Cu Nanoparticles+KOH

The Cu nanoparticles used in Comparative Example 2 and KOH particles were mixed at a weight ratio of 10:1, and the mixture was used as an electrocatalyst.

### Preparation of Cathode and Electrochemical System (Electrolytic Cell)

### Example 6

### Cathode

6 milligrams (mg) of the electrocatalyst prepared in Example 1, 1 mL of isopropanol (Samchun Pure Chemical, 99.8%), and 60 μL of Nafion solution (Nafion perfluorinated resin, 5 wt %, Sigma-Aldrich) were mixed, and then ultrasonically stirred for 30 minutes in a sonicator to prepare a cathode catalyst ink. As an electrode support, carbon paper (SGL GDL 39BB, CNL) was prepared with a size of 2.5 centimeters (cm)×2.5 cm. The carbon paper was placed on a heated substrate, and a cathode was prepared by spraying the cathode catalyst ink with a spray gun under vacuum conditions to remove the solvent.

### Anode

Iridium (IV) oxide (IrO₂, 99.9%, Alfa Aesar) was used as an oxygen evolution reaction (OER) catalyst. 30 mg of the iridium (IV) oxide, 1 mL of isopropanol, and 300 μL of Nafion solution were mixed and ultrasonically stirred in a sonicator for 30 minutes to prepare an anode catalyst ink. An anode was prepared by spraying the anode catalyst ink with a spray gun to a platinized titanium screen mesh (Ti-Pt mesh, 0.002 inch, 9 cm², FuelCellStore).

### Preparation of Membrane Electrode Assembly Electrochemical System (Electrolytic Cell)

An anion-exchange membrane (AEM, Sustainion X37-50 grade RT membrane, Dioxide Materials Inc.) was immersed in 1 M KOH solution for 48 hours to exchange Cl⁻ ions with OH⁻ ions, and then washed with an excess of distilled water for activation. A membrane electrode assembly was prepared by placing the cathode, the anode, and the AEM disposed therebetween, between a 904L stainless steel cathode gas flow channel for the cathode and a titanium gas flow channel for the anode. The area of the membrane electrode assembly was 5 cm². A membrane electrode assembly electrochemical system was prepared using a Complete 5 cm² electrolyzer from Dioxide Materials company.

### Examples 7 to 10

An electrolytic cell was prepared in the same manner as in Example 6, except that the electrocatalysts prepared in Examples 2 to 5 were each used.

### Comparative Examples 4 to 6

An electrolytic cell was prepared in the same manner as in Example 6, except that the electrocatalysts prepared in Comparative Examples 1 to 3 were each used.

### Evaluation Example 1: XRD Analysis

XRD was measured for the electrocatalyst powders prepared in Example 1, Example 3, and Comparative Example 1, and the measurement results are shown in FIG. 5.

As shown in FIG. 5, the Cu(OH)₂ nanorod prepared in Comparative Example 1 showed characteristic peaks consistent with theoretical values. Therefore, it was confirmed that the Cu(OH)₂ nanorods prepared in Comparative Example 1 were crystalline.

As shown in FIG. 5, in the XRD spectrum of the electrocatalyst (ZrCu_seq) prepared in Example 1, a first peak derived from a (021) plane at a diffraction angle of 2θ=24.0±1.0° 2θ and a second peak derived from a (002) plane at a diffraction angle of 2θ=24.0±1.0° 2θ were shown.

In the electrocatalyst prepared in Example 1, it was confirmed that the Cu(OH)₂ nanorods were still crystalline had a lower peak intensity and an increased peak half width, compared to the Cu(OH)₂ crystalline nanorods in Comparative Example 1, but were still crystalline.

As shown in FIG. 5, the XRD spectrum of the electrocatalyst (ZrCu_seq) prepared in Example 3 was free of a first peak derived from a (021) plane at a diffraction angle of 2θ=24.0±1.0° 2θ, and was also free of a second peak derived from a (002) plane at a diffraction angle of 2θ=24.0±1.0° 2θ.

The Cu(OH)₂ nanorods prepared in Example 3 did not show a peak corresponding to the Cu(OH)₂ crystalline nanorods in Comparative Example 1, and thus it was confirmed that the Cu(OH)₂ nanorods were amorphous.

### Evaluation Example 2: EDS Analysis

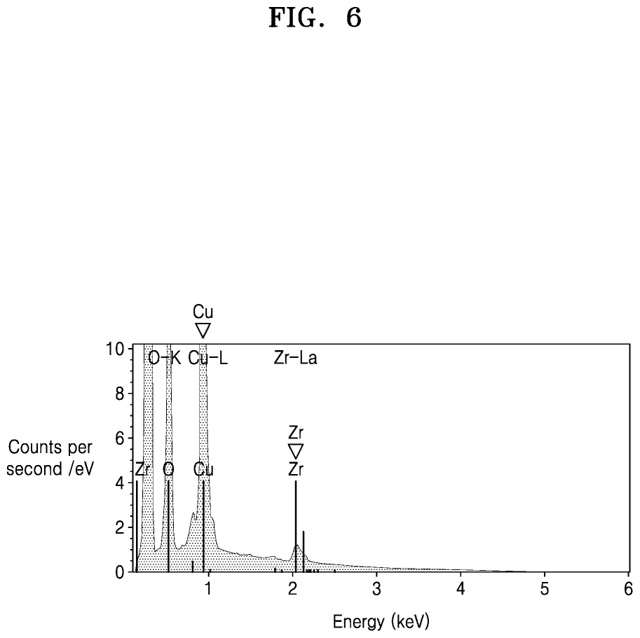

EDS for the electrocatalyst powder prepared in Example 1 was measured, and the measurement results are shown in FIG. 6.

As shown in FIG. 6, the Cu peak derived from Cu(OH)₂ nanorods and the Zr peak derived from ZrOₓ nanoparticles were confirmed.

### Evaluation Example 3: Catalyst Performance Evaluation

In each of the electrolytic cells prepared in Examples 6 to 10 and Comparative Examples 4 to 6, humidified high-purity carbon dioxide gas was supplied to the cathode at a flow rate of 100 standard cubic centimeters per minute (sccm), and 50 mL of 0.1 M KHCO₃ was circulated to the anode at 17 rpm. The current density (milliamperes per square centimeter, mA/cm²) at a cell voltage of −4.0 volts (V), multicarbon compound Faraday efficiency (FE), and ethylene Faraday efficiency (FE) were each measured. Some of the measurement results are shown in Table 1. Faraday efficiency herein may refer to the efficiency with which charge (electrons) is transferred in a system facilitating an electrochemical reaction.

TABLE 1

| | Current | Multicarbon | |
|---|---|---|---|
| | density | compound FE | Ethylene FE |
| | [mA/cm²] | [%] | [%] |
| Example 6 | −377 | 43 | 30 |
| (Sequential | | | |
| precipitation | | | |
| method, Zr 10 at %) | | | |
| Example 7 | −450 | 61 | 38 |
| (sequential | | | |
| precipitation | | | |
| method, Zr 20 at %) | | | |
| Example 8 | −235 | 24 | 12 |
| (co-precipitation method, | | | |
| Zr 10 at %) | | | |
| Comparative | −230 | — | — |
| Example 4 | | | |
| (Cu(OH)₂ | | | |
| nanorods only) | | | |
| Comparative | −66 | 7 | 6 |
| Example 5 | | | |
| (Cu nanoparticles | | | |
| only) | | | |

As shown in Table 1, the electrocatalysts of Examples 1 to 5 used in the electrolytic cells of Examples 6 to 8 had an increased current density compared to the electrocatalysts of Comparative Examples 1 and 2 used in the electrolytic cells of Comparative Examples 4 and 5.

It was determined that the electrocatalysts of Examples 1 to 3 used in the electrolytic cells of Examples 6 to 8 included both the first nanostructure and the second nanostructure at the same time, thereby providing an increased number of types of reaction sites compared to the electrocatalysts of Comparative Examples 1 and 2 used in the electrolytic cells of Comparative Examples 4 and 5, thereby improving catalytic activity.

The electrocatalysts of Examples 1 and 2 used in the electrolytic cells of Examples 6 and 7 showed improved selectivity for multicarbon compounds and improved selectivity for ethylene compared to the electrocatalyst of Example 3 used in the electrolytic cell of Example 8.

It was determined that, by including first and second nanostructures having different structures, the electrochemical catalysts of Examples 1 and 2 used in the electrolytic cells of Examples 6 and 7 had improved selectivity compared to the electrochemical catalyst of Example 3 used in the electrolytic cell of Example 8.

Although not shown in Table 1, the electrocatalyst of Comparative Example 3 used in the electrolytic cell of Comparative Example 6 had poor selectivity for multicarbon compounds and poor selectivity for ethylene compared to the electrocatalyst of Example 1 used in the electrolytic cell of Example 6.

According to an aspect of the disclosure, the electrocatalyst may provide improved catalytic activity for the carbon dioxide reduction reaction by simultaneously including the first nanostructure and the second nanostructure at the same time.

In addition, the electrocatalyst may provide improved selectivity for multi-carbon compounds by having the first nanostructure and the second nanostructure that have different structures.

Although exemplary embodiments have been described in detail with reference to the attached drawings, the inventive concept is not limited to these examples. It is obvious that anyone with ordinary knowledge in the technical field to which the inventive concept belongs may derive various examples of changes or modifications within the scope of the technical idea described in the claims, and these are naturally within the technical scope of the inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electrocatalyst comprising:
a first nanostructure comprising copper hydroxide; and
a second nanostructure comprising
a metal of Groups 2, 4, or 11 to 14 of the Periodic Table of Elements, other than copper,
a metal oxide of the metal,
a metal hydroxide of the metal, or
a combination thereof,
wherein the electrocatalyst is effective to catalyze conversion of carbon dioxide into a multicarbon compound.

2. The electrocatalyst of claim 1, further comprising
a complex comprising the first nanostructure and the second nanostructure,
wherein the second nanostructure is dispersed and supported on the first nanostructure, and wherein the second nanostructure has a different structure or a size from the first nanostructure.

3. The electrocatalyst of claim 1, wherein the first nanostructure and the second nanostructure each independently comprise a 0-dimensional nanostructure, a 1-dimensional nanostructure, a 2-dimensional nanostructure, a 3-dimensional structure, or a combination thereof, wherein
the 0-dimensional nanostructure comprises a nanoparticle, a nanocube, or a combination thereof,
the 1-dimensional nanostructure comprises a nanorod, a nanowire, a nanofiber, a nanotube, or a combination thereof, and
the 2-dimensional nanostructure comprises a nanosheet, a nanoflake, a nanoplate, a nanobelt, or a combination thereof.

4. The electrocatalyst of claim 1, wherein the first nanostructure comprises a nanoparticle, a nanorod, or a combination thereof, and the second nanostructure comprises the nanoparticle.

5. The electrocatalyst of claim 1, wherein an aspect ratio of the first nanostructure is about 5 to about 200.

6. The electrocatalyst of claim 1, wherein the first nanostructure comprises a primary structure comprising one nanostructure, a secondary structure that is an aggregate of a plurality of primary structures, or a combination thereof,
a major axis length of the primary structure is about 20 nanometers to about 1 micrometer and a minor axis length of the primary structure is about 1 nanometer to about 50 nanometers, and
a major axis length of the secondary structure is about 100 nanometers to about 5 micrometers, and a minor axis length of the secondary structure is about 5 nanometers to about 500 nanometers.

7. The electrocatalyst of claim 1, wherein the first nanostructure comprises a crystalline nanostructure, and
the electrocatalyst comprises a first peak at a diffraction angle of 24±1°2θ and a second peak at a diffraction angle of 24±1°2θ, when analyzed by X-ray diffraction using CuKα radiation.

8. The electrocatalyst of claim 1, wherein the first nanostructure comprises an amorphous nanostructure, and
the electrocatalyst is free of a first peak at a diffraction angle of 24±1°2θ, and is free of a second peak at a diffraction angle of 24±1°2θ, when analyzed by X-ray diffraction using CuKα radiation.

9. The electrocatalyst of claim 1, wherein the first nanostructure further comprises copper metal, copper oxide, or a combination thereof,
and the copper oxide is represented by CuₓO_{y} wherein 0<x≤1, and 0<y≤1.

10. The electrocatalyst of claim 1, wherein
the metal is Ba, Sr, Ca, Mg, Zr, Ti, Ag, Au, B, Al, In, Sn, or a combination thereof,
the metal oxide comprises BaOₓ wherein 0<x≤1, SrOₓ wherein 0<x≤1, CaOₓ wherein 0<x≤1, MgOₓ wherein 0<x≤1, ZrOₓ wherein 0<x≤2, TiOₓ wherein 0<x≤2, Ag₂Oₓ wherein 0<x≤1, Au₂Oₓ wherein 0<x≤3, B₂Oₓ wherein 0<x≤3, Al₂Oₓ wherein 0<x≤3, In₂Oₓ wherein 0<x≤3, SnOₓ wherein 0<x≤2, or a combination thereof, and
the metal hydroxide comprises Ba(OH)_{y} wherein 0<y≤2, Sr(OH)_{y} wherein 0<y≤2, Ca(OH)_{y} wherein 0<y≤2, Mg(OH)_{y} wherein 0<y≤2, Zr(OH)_{y} wherein 0<y≤4, Ti(OH)_{y} wherein 0<y≤4, Ag(OH)_{y} wherein 0<y≤1, Au(OH)_{y} wherein 0<y≤3, B(OH)_{y} wherein 0<y≤3, Al(OH)_{y} wherein 0<y≤3, In(OH)_{y} wherein 0<y≤3, Sn(OH)_{y} wherein 0<y≤4, or a combination thereof.

11. The electrocatalyst of claim 1, wherein the second nanostructure comprises an amorphous nanostructure,
a size of the second nanostructure is smaller than a size of the first nanostructure, and
a size of the second nanostructure is 100 nanometers or less.

12. The electrocatalyst of claim 1, wherein a content of the metal in the second nanostructure is greater than 0 atomic percent and less than about 50 atomic percent, based on a total metal amount in the first nanostructure and the second nanostructure.

13. The electrocatalyst of claim 1, further comprising a carbon-containing support,
wherein at least one of the first nanostructure or the second nanostructure is supported on the carbon-containing support, and
the carbon-containing support comprises carbon black, carbon nanotube, graphene, carbon nanofiber, graphite, or a combination thereof.

14. A cathode comprising the electrocatalyst of claim 1.

15. An electrochemical system comprising:
the cathode of claim 14;
an anode; and
an electrolyte disposed between the cathode and the anode.

16. The electrochemical system of claim 15, wherein the electrolyte comprises a liquid electrolyte, a solid electrolyte, a gel electrolyte, or a combination thereof, and
wherein the electrochemical system is an H-type electrochemical system, a flow electrochemical system, or a membrane electrode assembly electrochemical system.

17. A method of preparing an electrocatalyst, the method comprising:
providing a first nanostructure; and
disposing a second nanostructure on the first nanostructure to prepare the electrocatalyst,
wherein the first nanostructure is a 1-dimensional nanostructure, and the second nanostructure is a 0-dimensional nanostructure, and
wherein the first nanostructure comprises copper hydroxide, and
the second nanostructure comprises
a metal of Groups 2, 4, or 11 to 14 of the Periodic Table of Elements, other than copper,
a metal oxide of the metal,
a metal hydroxide of the metal, or
a combination thereof.

18. The method of claim 17,
wherein the providing of the first nanostructure comprises:
preparing a first solution comprising a precursor of the first nanostructure; and
adding a first basic solution to the first solution to prepare a second solution comprising the first nanostructure, and
wherein the disposing the second nanostructure on the first nanostructure comprises:
adding a third solution comprising a precursor of the second nanostructure to the second solution to prepare a fourth solution;
adding a second basic solution to the fourth solution to prepare a fifth solution comprising a first precipitate; and
separating the first precipitate from the fifth solution.

19. A method of preparing an electrocatalyst, the method comprising:
simultaneously preparing a first nanostructure and a second nanostructure disposed on the first nanostructure to prepare the electrocatalyst,
wherein the first nanostructure and the second nanostructure are each a 0-dimensional nanostructure, and
wherein the first nanostructure comprises copper hydroxide, and
the second nanostructure comprises
a metal of Groups 2, 4, or 11 to 14 of the Periodic Table of Elements, other than copper,
a metal oxide of the metal,
a metal hydroxide of the metal, or
a combination thereof.

20. The method of claim 19, wherein the simultaneous preparing of the first nanostructure and the second nanostructure disposed on the first nanostructure comprises
preparing a sixth solution comprising a precursor of the first nanostructure and a precursor of the second nanostructure,
adding at least one of a first basic solution or a second basic solution to the sixth solution to prepare a seventh solution comprising a second precipitate, and
separating the second precipitate from the seventh solution to prepare the electrocatalyst.
